(19) United States
(12) Patent Application Publication
(10) Pub. No.: US 2007/0271544 A1
(43) Pub. Date: Nov. 22, 2007

(54) Security sensing module envelope

(76) Inventor: Rolf Engstrom, Coto de Caza, CA (US)

Correspondence Address: NATH & ASSOCIATES, PLLC, 112 South West Street, Alexandria, VA, 22314, US

(21) Appl. No.: 11/436,980

(22) Filed: May 19, 2006

(51) Int. Cl. G06F 17/50

(52) U.S. Cl. 716/15

(57) ABSTRACT

A circuit module for user data entry is provided with a cover in electrical communication with the circuit module. The cover has a plurality of circuit elements and circuit traces which result in particular electrical characteristics sensed by the circuit module.

### FIELD OF THE INVENTION

This invention relates to data security for point of sale (POS) transactions such as credit transactions, debit card transactions and the like. More particularly, the invention relates to providing security for data entry such as credit card data and purchasing data, and for authorising electronic payment transactions.

### BACKGROUND OF THE INVENTION

Transactions, such as payment by credit or debit card, also known as electronic fund transfer (EFT), are rapidly becoming the preferred method of payment in many places. The number of payment cards issued is predicted to soar over the coming years, along with the number of purchases made using such cards. There are, however, serious concerns regarding the security of EFT systems and their robustness in resisting fraud.

Merchants who wish to accept EFT payments must install a terminal for authorising electronic fund transfers at the point of sale (EFTPOS). An EFTPOS terminal typically comprises a payment card reader device, an operator input device such as a keypad, an output display screen, an EFT processing engine, a database for recording transaction details, and a connection with further transaction processing equipment.

Organizations that oversee the use of EFT networks for payment transactions impose certain governing standards and the EFTPOS terminals must be configured accordingly. In the field of transaction data entry such as data entry for credit cards and debit cards, it is required to provide security of the transactions. If the transactions involve card readers it is often the case that it is required to providing a secure entry terminal. This becomes particularly important in cases in which, third party intruders may attempt to intercept the data. An example of such equipment is a credit card reader with a device for reading a personal identification number. The credit card reader includes an interface device such as a magnetic strip reader or smart card reader, and is generally coupled with a further data entry device such as a user entry device. The further data entry device provides for entry of user data as a personal identification number (pin) that is matched to the user's account. In general, it is desired to protect the keypad-entered data, since it is presumed that multiple people have access to data on a card used in cooperation with the keypad-entered data. Since the data entry through a keypad is relatively simple, it is possible for an intruder to intercept the data at the keypad module. It is possible to configure the keypad itself make some types of intrusion apparent to the casual user, but if an intruder is able to access a user interface device without damaging the keypad, data entered at the keypad would be compromised.

The user data entry device may be used independently of a card reader. While in many environments, a physical card or key is used, there are instances where the equipment for reading the physical key is not performed or is performed external to the equipment. Regardless, security of the manual key entry device is important.

The purpose of such equipment is to automatically enter they data, as well as to provide a degree of security by means of a readable card, in combination with the user's additional data such as the PIN. In one arrangement, the only way the account can be accessed remotely is by means of properly reading the card, in combination with the user's additional data such as the PIN. If an unauthorized party is able to access this information, the unauthorized party may be able to duplicate the data in the card. For example, given the access to the PIN number, the unauthorized party is able to replicate the user, in which an unskilled observer would see that someone had attempted to maliciously gain access to secured data. Therefore the PIN number is used as a secure point. A higher level is “tamper-resistant”, in which the equipment actively resists tampering by use of a self-destruct mechanism, an impermeable substance that coats the components storing sensitive data such as a polymer-based coating, other so-called “conformal coating”, or some other process. Furthermore, this equipment may encrypt input/output lines, mislabel parts, and perform other types of obfuscation.

There are systems that provide for tamper evident packaging. Additionally, some electronic devices become disabled upon the occurrence of particular conditions occur. For example, some radios manufactured by Becker Autoradio (Harmon Becker) will go to a “security mode” by which a predetermined code must be entered in order for the radio to function normally. The Becker Autoradio “security mode” is typically invoked by a power supply interruption involving the primary power supply (accessory power) and maintenance power supply (battery). In this manner, an attempt to bypass a vehicle's electrical or security system results in a radio becoming incapacitated, but easily reactivated by an owner or car dealer with the code.

### SUMMARY

According to the present invention, a data entry device capable of receiving user interface data includes a circuit module capable of communicating data and a secured a user input device on the circuit module. A cover on the circuit module is configured so as to establish an electrical parameter according to a positioning of the cover on the circuit module. Removal of the cover from the circuit module results in a change in the electrical parameter, and in the event of removal of the cover, the circuit module is disabled or ceases to function normally. This prevents unauthorized access to the data through the circuit module. The cover may be adhesively fixed to the circuit module so that disturbance of the connection of the cover with the circuit module upon unauthorized access in a manner which results in the changed electrical parameter.

In one configuration, a user input device, such as a includes a keypad data entry device is configured such that unauthorized access to the data would require visually disturbing the keypad user input device or disturbing the cover in such a manner as to change the electrical parameter.

In a further embodiment, at least one external contact point on the circuit module is in alignment with a contact point on the cover. The circuit module is able to read a value across the external contact point, and values read by the module through the external contact point indicates an integrity of a circuit extending through the cover.

In a further configuration, the circuit module is configured to break or otherwise become disabled should the cover be disturbed sufficiently to indicate an attempt at intrusion. This can be achieved by a frangible region on the module or by an arrangement which promotes delamination of the module upon removal of the cover.

In a further embodiment of the invention, an electrical parameter of the cover is sensed. By establishing change limits for the change in the electrical parameter consistent with removal of the cover or a possible intrusion through the cover, and intrusion into the module through the cover resulting in a change in the electrical parameter is detected. The change in the sensed electrical parameter exceeding the change limits is responded to by disabling to the module such that the circuit module ceases to function normally, thus preventing unauthorized access to the data through the circuit module.

### BRIEF DESCRIPTION OF THE DRAWINGS

FIG. 1 is a diagram showing an edge view of a keyboard module used with the present invention.

FIG. 2 is a diagram showing the module of FIG. 1 with a cover attached to the module.

FIG. 3 is an elevated view of the module.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

### Overview

In accordance with the present invention, a circuit module with a data entry function is provided with a flexible circuit security wrapper. The flexible circuit security wrapper includes circuit connections and devices on the module that determine circuit parameters of the module by means of electrical connections between the wrapper and the internal components of the module. Disturbance of the circuit parameters consistent with intrusion or tampering is sensed by the module which then becomes disabled.

In one configuration, a keypad and display are provided. The circuit security wrapper is configured so that the user has free access to a keypad and display, but access to the underlying printed circuit board results in disturbing the circuit security wrapper. When the entry device is configured, the circuit security wrapper is connected with external connection points, so that circuit parameters presented by the wrapper are incorporated into the circuitry of the data entry device. This protects the keypad-entered data by assuring that the module into which the data is entered is secure.

The data entry device may transmit its data in any secure fashion, for example by transmitting the data into encrypted form. One example of data transmission, used with some POS terminals, is the DES (Data Encryption System) algorithm based on ANSI-x9.81. “Beigeboxing” (intercepting the data transmission) would be insufficient because the data itself is protected. Thus, for an intruder to have access to the data, the user must either observe the input of the data or break into the data entry device.

In one particular aspect of the invention, a substantial change in the circuit parameters presented by the wrapper causes the data entry device to become disabled. In a particular variation on the disabling of the data entry device, disabling of the device results in the data entry device self-destructing under particular operating circumstances.

The circuit module has external contact points that engage the circuit security wrapper. This enables the circuit module to read a value across the external contact points that correspond to the value established by the circuit security wrapper in contact with the external contact points. When the circuit module is configured, an adjustment is made so that the values accepted across the external contact points match the values that can be anticipated by engagement of the external contact points with the circuit security wrapper. A range of these values is selected in accordance with anticipated change in the characteristics of the connection through the external contact points, but narrow enough to detect tampering. If the range is sufficiently narrow, these values would not be likely guessed by an intruder. Further, if the change is detected during tampering or intrusion, the module would be disabled.

In addition to the external contact points, a standard circuit connection such as a flexible lead connection, is established between the security wrapper and the circuit module. The standard circuit connection works in cooperation with the external contact points to assure the functionality of the security wrapper. This makes it more likely that attempted removal or penetration causes a detectable permanent change in electrical state of the security wrapper. Additionally, routine circuit functions of the circuit module can be routed through the security wrapper via the standard circuit connection in a manner that would not be practical if the external contact points were used.

The circuit security wrapper is adhesively attached to the circuit module. This accomplishes at least three things:

1. By fixing the circuit security wrapper to the circuit module, the engagement with the external contact points is stabilized. Thus, values established across the external contact points remain constant.

2. If the adhesive is strong enough, removal of the circuit security wrapper will result in damage to at least the circuit security wrapper, and possibly the circuit board. Thus if an intruder attempts to tamper with the circuit security wrapper, the module will be rendered inoperable.

3. An intruder would be likely to damage or alter circuits within the circuit security wrapper in an attempt to disassemble the wrapper.

The circuit security wrapper is provided with apertures that are positionable over various external input/output portions of the circuit module. Examples would include a visual display panel, keypad buttons and a card reader. By combining security features of the external input/output portions with the circuit security wrapper, security of a user input device is enhanced.

With the circuit security wrapper in place, the circuit module has circuit parameters established that are consistent with the circuit module's internal circuit parameters, modified by those of the circuit security wrapper. By way of example, if the impedance between two circuit locations TP1 and TP2 within the circuit module, but without the security wrapper is X, then the impedance between these points TP1 and TP2 would be changed by the attachment of the security wrapper. This change may vary in accordance with the method of attachment but it is possible to establish broad parameters for the impedance. If the impedance is within the broad parameters, one can deduce that:

1. The parameters between TP1 and TP2 are substantially different from the parameters of TP1 and TP2 without the circuit security wrapper.

2. If the parameters are set narrowly enough, it is unlikely that a random selection of parameters will satisfy the circuit parameters established by the security wrapper.

If the circuit parameters change in any way inconsistent with anticipated changes in the power supply for the circuit module, then it is presumed that the circuit security wrapper has been disturbed. Thus, while it may be possible to determine what the parameters were between TP1 and TP2, the removal of the circuit security wrapper will effect a change in the parameters during the event of removal. This itself represents a change in circuit parameters, even if the parameters are later restored.

In accordance with one aspect of the invention, a substantial change in circuit parameters between predetermined circuit points on the circuit module will result in the circuit module becoming disabled. Once the circuit module is disabled, operator intervention is required, such as the entry of a reset code. The result is that the module cannot function without operator intervention if an intrusion results in the removal or substantial disturbance of the circuit security wrapper. This permits the circuit module to use the circuit security wrapper to automatically detect if the circuit security wrapper is disturbed.

In a further embodiment of the invention the circuit parameters altered by the circuit security wrapper are incorporated into data transmitted to a remote site. If the user input data is also transmitted to the remote site, the remote site receives the altered data. By providing the remote site with a key for the altered data, it is possible for a remote host to automatically detect if the data is transmitted with the circuit security wrapper disturbed. This also permits the code for resetting the module to be secured at a remote site, so that resetting the module requires transmitting a reset program procedure call from a remote location.

The module is designed so that data required to transmit user information is erased when the circuit parameters established by the security wrapper is substantially changed. In that manner, if the security wrapper is disturbed by an intruder, the module becomes disabled.

In addition to the circuit parameters, the module is provided with a destructive interface to which the security wrapper is attached. The destructive interface is such that, if the security wrapper is removed, the interface is damaged to an extent that the module is no longer usable. This can be accomplished by providing a mounting surface configured such that, when the security wrapper is attached, removal of the security wrapper will sufficiently delaminate the module's circuit board as to damage the at least one circuit path within the circuit board.

### Keyboard Configuration

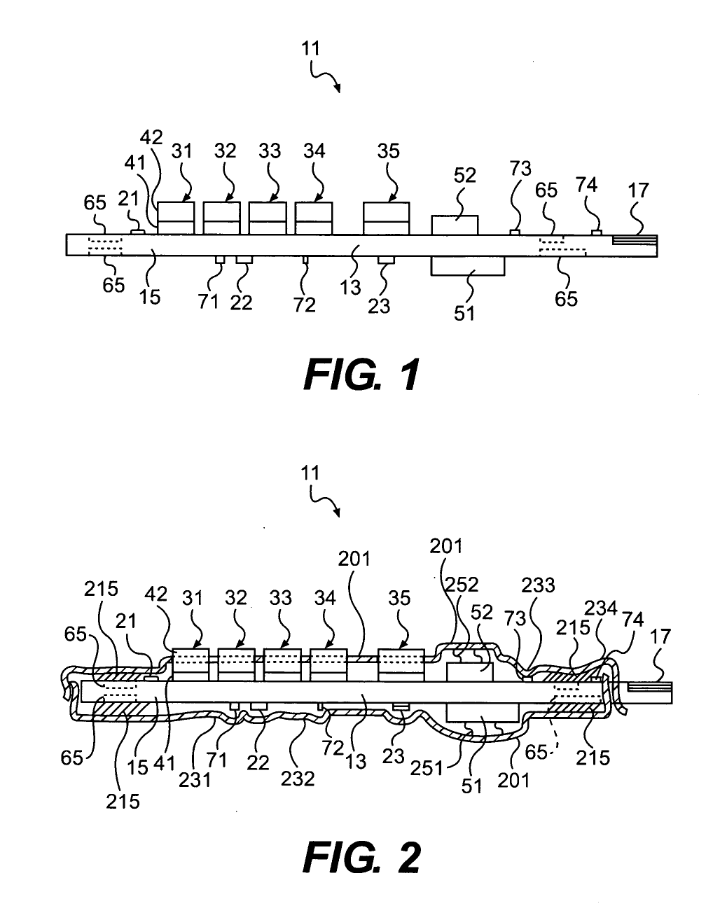

FIG. 1 is a diagram showing an edge view of a keyboard module 11 adapted for use with the present invention. The module 11 includes a printed circuit board (PCB) 13 with circuit traces (not shown), an external connection 17, located at or near an edge 19 of the PCB 13. The PCB 13 has mounted thereon a plurality of active electronic components 21-23. The PCB 13 has mounted thereon a plurality of keys 31-35, typically arranged in a 3×4 array (including keys 31-34), with additional keys for control functions (including key 35). The keys include switch components 41 and key buttons 42, so that the key buttons 42 are accessible to the user in the customary manner. The keys 31-35 are provided with a tamper resistant or tamper evident feature, so that tampering with the module 11 through the keys 31-35 either disables the module 11 or is apparent to the casual user.

FIG. 2 is an end view of the keyboard module 11 of FIG. 1. Additional keys 37, 38, 39 are depicted, such that keys 21-39 are part of the 3×4 array.

The keys 31-35 are a user interface, and are given by way of example. Other types of user interfaces include but are not limited to a card reading device, a radio transponder, and a biometric reader.

The external connection 17 is intended for connecting the module 11 to external equipment or to an external communication link in order to transfer data from the module 11 to the outside world. The module 11 is configured such that, so long as the module is secure, data transferred through the external connection 17 can be presumed to be reliable and secure. In addition to external connection 17, additional circuit connections 51, 52 are provided. The additional circuit connections permit ribbon connectors (not shown in FIG. 1) to be plugged into the module 11. The additional circuit connections 51, 52 are mounted on the PCB 13 inboard of the edges 19 of the PCB 13, so that the connections are inside, away from the external boundaries of the PCB 13.

A plurality of self-destructive portions or frangible areas 65 may optionally be incorporated into the PCB 13. These are constructed such that an adhesive bond on the surface of the PCB 13 at the frangible areas 65 results in delamination of the PCB 13. The frangible areas 65 may also include circuit traces or other elements (not separately shown) configured such that damage to the frangible areas causes the PCB 13 to fail or destroy its data. In one configuration, the frangible areas 65 have characteristics such that removal of an attached component results in destructive delamination of the PCB 13. The frangible areas 65 may include a groove 67 that provides an additional adhesion surface, making delamination of the PCB 13 more likely if a component bonded at groove is forcibly removed.

The PCB 13 has a plurality of external contacts. The external contacts 71-74 are in communication with the circuitry of the PCB 13 so that electrical connections through one or more of the external contacts 71-74 can be sensed by the module 11. In the case of no external cover on the PCB 13, the external contacts 71-74 will register as open circuits. As will be described, the use of a cover will result in impedances through the contacts 71-74 which are dependant on the particular alignment of the cover.

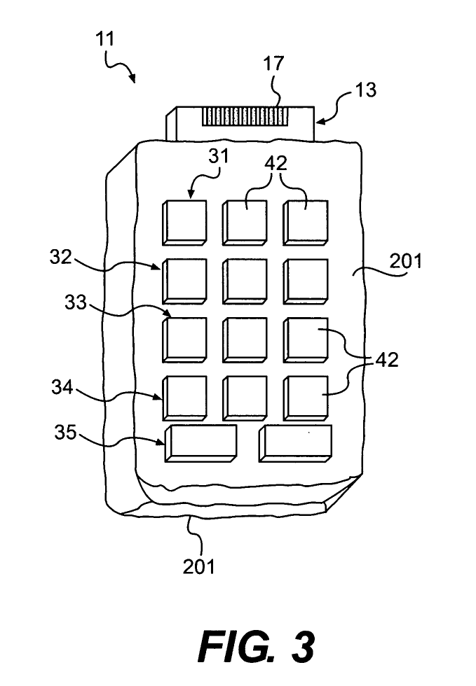

FIG. 2 is a diagram showing the module 11 with a circuit security wrapper 201 attached to the module 11. The circuit security wrapper 201 is provided as a cover, as shown in elevation in FIG. 3.

The circuit security wrapper 201 in the exemplary embodiment of the invention is a PCB circuit security wrapper, sold as a “GORE™ D³ Tamper Respondent Enclosure”, manufactured by W.L. Gore & Associates, Inc., Elkton, Md., US. In the example, the circuit security wrapper 201 is a flexible version, which is wrapped around the PCB 13 and its components, but it is also possible to implement the invention with a hard shell version, also sold as a “GORE™ D³ Tamper Respondent Enclosure”. The wrapper includes a plurality of circuit traces and circuit elements therein. This establishes, within the circuit security wrapper 201, a random or pseudorandom set of connections, including at least passive circuits, so that contact across the wrapper has a predetermined but not predictable electrical impedance. The circuit security wrapper 201 is folded around the PCB 13 and is bonded to the PCB 13. In particular, the bonding is applied so as to include substantial portions of the frangible areas 65, as represented at 215. The bonding at the frangible areas 65 is such that removal of the circuit security wrapper 201 will result in damage to the circuit traces on the PCB 13 as well as altering the electrical characteristics of the circuit security wrapper 201. The circuit security wrapper 201 includes connections 231-234 which mate with the external contacts 71-74. The circuit security wrapper 201 is configured so that the particular properties between the connections 231-234 are uniquely established for each assembly of a circuit security wrapper 201 with a PCB 13.

The circuit module 11 to which the circuit security wrapper 201 is applied to includes a keypad (keys 31-35) and keypad reader that includes circuitry incorporated onto the PCB 13. Alternatively, the circuit module 11 is used to read a user's card or other device, such as a magnetic strip reader or a smartcard reader. These keypad, keypad reader and other user interface components must be functional with a minimum of interference from the circuit security wrapper 201. The circuit security wrapper 201 therefore has gaps for the keys 31-35. This leaves the module 11 exposed at the keys 31-35, but the design of the keys 31-35, including the switch components 41 and the key buttons 42. The switch components 41 and the key buttons 42 are themselves designed to be sufficiently secure to protect the module 11.

The bonding, while shown at limited areas 215 can be extended to include substantial portions of the PCB 13, although it is preferable that the connections 231-234 with external contacts 71-74 are accommodated by the bonding. It is also possible to use conductive or semiconductive material for the bonding, so that the connection 231-234 between the circuit security wrapper 201 and the PCB 13 at external connections 71-74 can be effected when the circuit security wrapper 201 is bonded to the PCB 13. One example of a bonding technique is the use of a conductive solder or plated bonding material, such that removal of the circuit security wrapper 201 results in a delamination of a circuit trace at the location of the bond. The solder trace may be the frangible portion of the frangible area 65 or may be part of the circuit security wrapper 201. In either case, once the circuit security wrapper 201 has been removed from the PCB 13, it becomes difficult to re-bond the cover to the PCB 13 and yet retain similar electrical characteristics.

Ribbon connector cables 251, 252 establish reliable connections between the circuit security wrapper 201 and the PCB 13. The ribbon connector cables 251, 252 may provide return paths corresponding to the connections 231-234. The ribbon connector cables 251, 252 may also be used to provide circuit paths which indicate a disruption in current through circuitry internal to the circuit security wrapper 201.

This configuration provides that the module 11 will be disabled, either permanently, by erasing data or require authorized reset procedure should any of the following conditions occur:
The circuit parameters between the external contacts 71-74 or through the frangible areas 65 change substantially so as to indicate intrusion through the circuit security wrapper 201.
The circuit parameters at the external contacts 71-74 or through the frangible areas 65 change in a manner which indicates the circuit security wrapper 201 being at least partially removed.
The module 11 is disconnected at external connection 17.
Circuit connections through the ribbon connections 251, 252 indicate a change in properties, consistent with attempted removal or a change in the integrity of the circuit security wrapper 201.
A circuit connection indicating a secure connection is lost.

These conditions are generally similar, and indicate a compromise in the security of the module 11 and its connection to an external system. In some cases these conditions are consistent with routine maintenance, installation and external events, such as a power failure. If that's the case, then the module 11 can be reset in order to continue operation. Since the usual case is of the module 11 ultimately connected to an external system at a secure location, it is possible to provide the reset function on an automatic basis, for example after a known power failure.

Those skilled in the art will appreciate that the various illustrative logical blocks, modules, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic

1. A data entry device capable of receiving user interface data, the data entry device comprising:
a circuit module capable of communicating data;
a user input device on the circuit module;
a cover on the circuit module in electrical communication with the circuit module configured so as to establish an electrical parameter of the electrical communication according to a positioning of the cover on the circuit module, whereby removal of the cover from the circuit module results in a change in the electrical parameter; and
a circuit, responsive to the electrical parameter, to disable the circuit module upon change in the electrical parameter consistent with removal of the cover, such that in the event of removal of the cover, the circuit module ceases to function normally, thus preventing unauthorized access to the data through the circuit module.

2. The data entry device of claim 1, wherein the user input device includes a keypad data entry device, such that unauthorized access to the data would require visually disturbing the keypad data entry device or disturbing the cover in a manner which changes the electrical parameter.

3. The data entry device of claim 2, comprising the cover adhesively fixed to the circuit module, thus resulting in disturbance of the connection of the cover with the circuit module upon unauthorized access in a manner which results in the changed electrical parameter.

4. The data entry device of claim 1, comprising:
at least one external contact point on the circuit module;
a contact point on the cover aligned so as to establish ohmic contact with the external contact point on the circuit module;
device, discrete gate or transistor logic, discrete hardware components, or any combination thereof designed to perform the functions described herein.
The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.
a further circuit connection between the circuit module and the cover, thereby enabling the circuit module to read a value across the external contact point and the further circuit connection, whereby values read by the module through the external contact point indicates an integrity of a circuit extending through the cover.

5. The data entry device of claim 1, comprising:
at least one frangible region on the circuit module;
a circuit connection incorporating the frangible region; and
a bond attaching the cover on at least a portion of the frangible region, such that forced removal of the cover results in detectable fracture of the frangible region as a result of disturbing the circuit connection.

6. The data entry device of claim 5, wherein the frangible region includes a groove, the grove facilitating delamination of the circuit module in the event of forced removal of the cover.

7. The data entry device of claim 1, comprising:
the module including a printed circuit board (PCB) with circuit elements thereon; and
the cover folded around the and is bonded to the PCB, such that removal of the cover results in damage a circuit traces on the PCB.

8. The data entry device of claim 1, comprising:
the module including a printed circuit board (PCB) with circuit elements thereon; and
the cover folded around the and is bonded to the PCB, such that removal of the cover results in altering electrical characteristics of the combination of the cover with the PCB.

9. The data entry device of claim 1, comprising:
a user interface on the circuit module, the user interface provided with a tamper resistant or tamper evident feature, such that tampering with the module through the user interface either disables the module or is apparent to a user; and
at least one gap in the cover corresponding to the user interface, thereby exposing the user interface for use.

10. The data entry device of claim 9, wherein:
the user interface includes a plurality of keys on the circuit module; and
the keys have a tamper resistant or tamper evident feature provided thereon, such that tampering with the module through the keys either disables the module or results in an indication of tampering apparent to a user.

11. The data entry device of claim 1, comprising:
a plurality of keys on the circuit module, the keys provided with a tamper resistant or tamper evident feature, such that tampering with the module through the keys either disables the module or is apparent to a user; and
a plurality of gaps in the cover corresponding to the keys, thereby exposing the keys for use.

12. The data entry device of claim 1, comprising:
the module including a printed circuit board (PCB) with circuit elements thereon;
at least one external contact on the PCB;
at least one connection on the cover mating with the external contact on the PCB; and
at least one further connection between the PCB and the cover, wherein a disturbance in at one of the connections results in a change in an electrical property of the combination of the PCB and the cover.

13. The data entry device of claim 1, comprising:
at least one frangible region on the circuit module;
a circuit connection incorporating the frangible region; and
a bond attaching the cover on at least a portion of the frangible region, such that the device responds by going to a disabled mode in response to one of the following conditions:
circuit parameters between contacts on the circuit module or through the frangible region change substantially so as to indicate intrusion through the cover;
circuit parameters at the contacts or through the frangible region changes in a manner which indicates at least partial removal of the cover;
disconnection of the module at an external connection; and
loss of a circuit connection indicating loss of a secure connection.

14. The data entry device of claim 13, comprising a reset mode for at least a subset of the conditions.

15. The data entry device of claim 13, comprising a reset mode, activated from an external location, for at least a subset of the conditions.

16. A method of protecting a circuit module having a user interface thereon and having a cover in electrical communication with the circuit module, the method comprising:
sensing an electrical parameter of the cover, whereby intrusion into the module through the cover results in a change in the electrical parameter;
establishing change limits for the change in the electrical parameter consistent with removal of the cover or a possible intrusion through the cover; and
responding to a change in the sensed electrical parameter exceeding the change limits by disabling to the module such that the circuit module ceases to function normally, thus preventing unauthorized access to the data through the circuit module.

17. The method of claim 16, further comprising using a reset code that, after disablement of the circuit module, the reset code provides a reset function to enable the normal operation of the circuit module.

18. The method of claim 17, further comprising providing the reset code from a remote host.

19. The method of claim 16, comprising:
using at least one external contact point on the circuit module and a contact point on the cover aligned so as to establish ohmic contact with the external contact point on the circuit module, and a further circuit connection between the circuit module and the cover;
using the circuit module to read a value across the external contact point and the further circuit connection;
establishing a range of values, the range selected in accordance with anticipated change in the characteristics of the connection through the external contact points absent tampering, but narrow enough to indicate tampering.

20. A system for protecting circuit module having a user interface thereon, the system comprising:
a cover in electrical communication with the circuit module;
means for sensing an electrical parameter of the cover, whereby intrusion into the module through the cover results in a change in the electrical parameter;
means for establishing change limits for the change in the electrical parameter consistent with removal of the cover or a possible intrusion through the cover; and
means for responding to a change in the sensed electrical parameter exceeding the change limits by disabling to the module such that the circuit module ceases to function normally, thus preventing unauthorized access to the data through the circuit module.
